(19) United States
(12) Patent Application Publication
(10) Pub. No.: US 2026/0069392 A1
(43) Pub. Date: Mar. 12, 2026

(54) Dry Powder Inhalation System and Dry Powder Administration Method

(71) Applicant: ASG INSPIRATION LABORATORY (SINGAPORE) PTE. LTD., Singapore (SG)

(72) Inventors: Johnson Lee, Taipei City (TW); Sung Tsai Yu, Taipei City (TW); Hao-Wei Huang, Taipei City (TW); Jao Juen Hung, Taipei City (TW); Shih Pan Chao, Taipei City (TW); Philip Tan, Taipei City (TW)

(21) Appl. No.: 19/061,104

(22) Filed: Feb. 24, 2025

(30) Foreign Application Priority Data
Sep. 6, 2024 (TW) 113133985

(51) Int. Cl. A61D 7/04

(52) U.S. Cl. CPC A61D 7/04

(57) ABSTRACT

A dry powder inhalation system includes a breath detection device, a drug delivery device, and a computing device. The breath detection device is configured to monitor the breathing state of an animal and transmit the signals of the breathing state. The drug delivery device is configured to deliver the dry powder orally or nasally to the lungs of the animal. The computing device is configured to receive the signals of the breathing state, evaluate a stress state of the animal, predict a breathing cycle of the animal, and control the drug delivery device to release the dry powder during a non-stressed inhalation period for the animal to inhale the dry powder autonomously. A dry powder administration method is also disclosed.

### CROSS-REFERENCE TO RELATED APPLICATION

This application claims priority to Taiwan Patent Application No. 113133985, filed Sep. 6, 2024, the disclosure of which is hereby incorporated by reference in its entirety.

### BACKGROUND OF THE INVENTION

### Field of Invention

The present disclosure relates to a dry powder inhalation system for animals and a dry powder administration method for animals.

### Description of Related Art

Inhalation therapy is the preferred method of drug administration for treating respiratory diseases because (i) it delivers the medication directly to the site of action, resulting in a rapid onset of effect; (ii) it is painless, thereby improving patient compliance; and (iii) it avoids first-pass metabolism, thus reducing systemic side effects. Inhalation therapy involves delivering medication to the lungs of the recipient through the oral cavity or the nasal cavity to exert a therapeutic effect. In recent years, oral inhaled drugs (OID) have also been used to treat systemic diseases. However, the overall attrition rate for the development of OIDs is currently about 70%, which means that seven out of ten new candidate drugs fail to enter the clinical stage.

When inhaled drugs are administered to a recipient, their liquid or powdered aerosol enters the respiratory system through the oropharynx or the nasal cavity. The deposition of the inhaled drugs on the throat is ineffective and reduces the dose of the inhaled drugs that reaches the lungs. Furthermore, in clinical practice, there is a desire to minimize the deposition of the inhaled drugs on the throat to avoid side effects of the recipient.

Achieving the optimal inhalation deposition pattern in the lungs can effectively improve the success rate of animal experiments. The absorption and transfer of drugs into the blood can occur in all parts of the lung, but these processes are more likely to occur in the alveoli. Alveoli have a large surface area and relatively thin layers of epithelial and endothelial cells, which separate the drugs from alveoli. In the branching structure of the lung, drug inhalation is affected by the velocity and aerodynamic size distribution of the particles/droplets carrying the drug. These two parameters strongly influence the drug deposition pattern, which in turn affects the effectiveness of inhalation therapy.

Currently, animal experiments regarding inhaled drugs of dry powder mainly rely on the animals' autonomous breathing to deliver the drugs into the lungs. At present, in animal experiments, when drugs need to be administered via the bronchopulmonary route, three methods are usually adopted: (1) placing the animal in a closed chamber to inhale the drug; (2) using a medical nebulizer for oral inhalation of the drug; (3) directly dropping or injecting the drug into the trachea of the animal. However, it is difficult to ensure the effective inhalation of the drug and the uniformity of the inhaled dosage, or the operations of the above methods may be too complicated; therefore, these methods are not suitable for multiple administration of the drug to a single animal. Currently, for dry powder inhalation, there is no available inhalation method or device for animals in the market.

Animal-based inhalation studies are primarily conducted in rats, mice, or rabbits through drug exposure in a restraint chamber. Dogs and primates can also be tested in a more realistic environment through masks or helmets.

At present, based on the requirements of laws and regulations related to new drug development, preclinical experiments based on animals are needed. However, some hypotheses may be questioned in these preclinical experiments based on animals. The breathing of an animal is easily influenced by the surrounding environment and the animal's own physiological state, so the estimated amount of drug inhalation often differs significantly from the actual inhaled amount. This makes it challenging to use animal experimental results to evaluate the effects of inhaled drugs.

### SUMMARY OF THE INVENTION

Given the shortcomings of the prior art, one of the purposes of the present disclosure is to provide a practical dry powder inhalation system for animals and a dry powder administration method.

Some embodiments of the present disclosure provide a dry powder inhalation system including a breath detection device, a drug delivery device, and a computing device. The breath detection device is configured to monitor the breathing state of an animal and transmit the signals of the breathing state. The drug delivery device is configured to deliver the dry powder orally or nasally to the lungs of the animal. The computing device is configured to receive the signals of the breathing state, evaluate a stress state of the animal, predict a breathing cycle of the animal, and control the drug delivery device to release the dry powder during a non-stressed inhalation period for the animal to inhale the dry powder autonomously.

In some embodiments, the breath detection device includes a signal receiver and a transceiver interface device. The signal receiver is configured to detect the signals of the breathing state of the animal. The transceiver interface device is connected to the signal receiver and configured to transmit the signals of the breathing state to the computing device.

In some embodiments, the breath detection device is a lung sound detector that includes a vibrator, a plurality of signal receivers, and a transceiver interface device. The vibrator is configured to emit reference vibration signals. The plurality of signal receivers are configured to receive the respiratory vibration signals from the animal and the reference vibration signals from the vibrator. The transceiver interface device is connected to the plurality of signal receivers and transmits the respiratory vibration signals from the animal and the reference vibration signals from the vibrator to the computing device.

In some embodiments, the drug delivery device includes a conduit, a drug storage tank, and a gas ejection device. The conduit includes a gas inlet end and a gas outlet end. The drug storage tank is communicated with the conduit and configured to store the dry powder. The gas ejection device is communicated with the gas inlet end of the conduit and configured to eject a gas to the gas outlet end.

In some embodiments, the conduit of the drug delivery device is a hose, and the hose is configured to be inserted into the oral cavity or the nostrils of the animal.

In some embodiments, the drug delivery device further includes a one-way valve. The one-way valve is disposed in the conduit and configured to allow the gas to flow in the inhalation direction of the animal.

In some embodiments, the drug storage tank is located near the gas outlet end of the conduit.

In some embodiments, the drug delivery device further includes a drug release valve and a drug release controller. The drug release valve is disposed between the conduit and the drug storage tank. The drug release controller is electrically connected to the drug release valve and configured to receive a drug release instruction from the computing device to control the opening or closing of the drug release valve.

In some embodiments, the drug delivery device further includes a gas valve and a gas release controller. The gas valve is disposed between the gas ejection device and the gas inlet end of the conduit. The gas release controller is electrically connected to the gas valve and configured to receive a gas ejection instruction from the computing device to control the opening or closing of the gas valve.

In some embodiments, the dry powder inhalation system further includes a nasal mask. The nasal mask includes a body, a first airflow valve, a second airflow valve, and a nasal airflow controller. The first airflow valve and the second airflow valve are located in the body and are respectively disposed at positions corresponding to the two nostrils of the animal. The nasal airflow controller is configured to receive an inhalation control instruction from the computing device and close the first airflow valve and the second airflow valve during the non-stressed inhalation period of the animal.

In some embodiments, the dry powder inhalation system further includes a fixing auxiliary device. The fixing auxiliary device is configured to fix the drug delivery device.

In some embodiments, the fixing auxiliary device includes a muzzle. The muzzle is configured to fix the mouth of the animal.

In some embodiments, the fixing auxiliary device further includes a locking component. The locking component is configured to fix a portion of the drug delivery device at the locking position of the muzzle.

In some embodiments, the fixing auxiliary device also includes an upper mouthguard and a lower mouthguard. The upper mouthguard and the lower mouthguard are configured to prevent that animal from chewing the drug delivery device.

In some embodiments, the computing device uses the classification model to obtain a breathing pattern of the animal and predict the non-stressed inhalation period.

In some embodiments, the computing device is further configured to obtain the suitable dosage range of the dry powder for the animal.

In some embodiments, the dry powder inhalation system further includes: a drug recovery device. The drug recovery device is configured to collect an exhaled dry powder from the animal.

In some embodiments, the dry powder inhalation system further includes a holding chamber configured to accommodate the animal. The holding chamber includes a sleeve, and the sleeve is configured to position the snout of the animal close to the drug outlet of the drug delivery device.

In some embodiments, the dry powder inhalation system further includes an inhalation tower. The inhalation tower includes a plurality of holding chambers, wherein each of the holding chambers is provided with the drug delivery device.

In some embodiments, the dry powder inhalation system further includes a dry powder supply mechanism connected to the drug delivery device of each of the holding chambers.

Other embodiments of the present disclosure provide a dry powder administration method, which includes: placing a breath detection device near the lungs of an animal; disposing a drug delivery device, wherein the drug delivery device is configured to deliver a dry powder to the lungs of the animal through an oral cavity or a nasal cavity of the animal; monitoring the breathing state of the animal to evaluate the stress state of the animal and predict the breathing cycle of the animal; and ejecting the dry powder for inhalation by the animal during a non-stressed inhalation period.

In some embodiments, the dry powder administration method further includes: recovering an exhaled dry powder from the animal, and calculating an inhalation amount of the dry powder of the animal.

In some embodiments, the drug delivery device is inserted into the oral cavity of the animal, and the nasal cavity of the animal is masked during the non-stressed inhalation period.

In some embodiments, the animal is not anesthetized.

In some embodiments, before ejecting the dry powder for inhalation by the animal during the non-stressed inhalation period, ejecting a gas without the dry powder to the oral cavity or nasal cavity of the animal during another non-stressed inhalation period.

In some embodiments, the animal is suspended in a hammock.

In some embodiments, the animal is placed in a holding chamber.

### BRIEF DESCRIPTION OF THE DRAWINGS

Aspects of the present disclosure are best understood from the following detailed description when read with the accompanying figures. It is emphasized that, in accordance with the standard practice in the industry, various features are not drawn to scale and are for illustrative purposes only. In fact, the dimensions of the various features may be arbitrarily increased or reduced for clarity of discussion.

FIG. 1 is a schematic view of the operation of a dry powder inhalation system according to some embodiments.

FIG. 2A is a schematic view of a breath detection device according to some embodiments.

FIG. 2B is a schematic view of a breath detection device according to some embodiments.

FIG. 3 is a schematic view of a drug delivery device according to some embodiments.

FIG. 4 is a schematic view of a set of mouthguards for animals according to some embodiments.

FIG. 5 is a schematic view of a muzzle for an animal according to some embodiments.

FIG. 6 is a schematic view of a nasal mask for an animal according to some embodiments.

FIG. 7 is a schematic view of a drug delivery device according to some embodiments.

FIG. 8 is a schematic view of an operation in administering a dry powder to an animal according to some embodiments.

FIG. 9 is a schematic view of a dry powder inhalation system according to some embodiments.

FIG. 10 is a schematic view of a dry powder inhalation system according to some embodiments.

### DESCRIPTION OF THE INVENTION

The following disclosure provides many different embodiments, or examples, for implementing different features of the provided subject matter. Specific examples of components and arrangements are described below to simplify the present disclosure. These are, of course, merely examples and are not intended to be limiting. The examples disclosed below can be combined or replaced with each other under beneficial circumstances, and other examples can be added to one example without further description or explanation. In the following description, many specific details will be described to enable readers to fully understand the following embodiments. However, embodiments of the present disclosure may be practiced without these specific details.

As used herein, the term “connection” refers to the direct or indirect physical, electrical, or communication contact between two or more components. Furthermore, “connection” may also refer to the coordinated operation or action of two or more components. Furthermore, it should be understood that in the embodiments and claims of this application, the description involving “electrical connection” may broadly refer to a component being indirectly electrically coupled to another component through other component(s), or a component being directly electrically coupled to another component without the need for other component(s).

One of the purposes of the present disclosure is to address issues related to the device types used for administering inhaled drugs to animals. Early development work for drug formulations often requires preclinical animal experiments. Therefore, when a potential drug is being evaluated, consistency in drug delivery across trials is extremely important to more accurately ensure that drug delivery is as envisioned by the investigators. When an animal exhales, the delivered drug may be blown back, which can result in significant bias in estimates of drug delivery. Moreover, when the animal is in a state of tension, the breathing of the animal may be rapid, shallow or irregular, which can affect the amount of the dry powder inhaled into the lungs of the animal. Therefore, embodiments of the present disclosure are designed to spray dry powder so the animal can inhale the drug during a non-stressed inhalation period when the dry powder is administered to the animal through inhalation therapy.

In some embodiments, the dry powder inhalation system and the dry powder administration method disclosed herein can be applied to experimental animals, such as dogs, rabbits, guinea pigs, rats, and mice. In some embodiments, controlled inhalation of the drug is performed during a conscious inhalation period of the animal to help obtain more accurate preclinical experimental data.

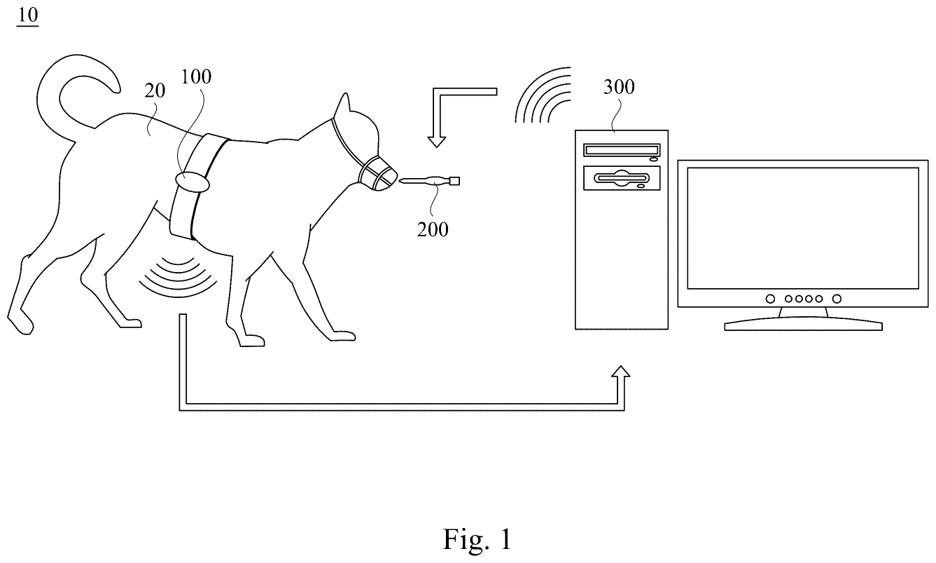

FIG. 1 shows a schematic view of the operation of a dry powder inhalation system according to some embodiments. The dry powder inhalation system 10 includes a breath detection device 100, a drug delivery device 200, and a computing device 300. The breath detection device 100 is configured to monitor the breathing state of the animal 20 and transmit the signals of the breathing state. The drug delivery device 200 is configured to apply dry powder orally or nasally to the lungs of the animal 20. The computing device 300 is configured to receive the signals of the breathing state, evaluate the stress state of the animal, predict a breathing cycle of the animal, and control the drug delivery device 200 to release the dry powder during a non-stressed inhalation period for the animal 20 to inhale the dry powder autonomously. The breath detection device 100, the drug delivery device 200, and the computing device 300 are all provided with communication elements to transmit signals and instructions, such as by wired or wireless communication. Wireless communication is preferred. Wireless communication may be, for example, WIFI, Bluetooth, or the like.

The breath detection device 100 is communicatively connected to the computing device 300 to transmit the signals of the breathing state. The computing device 300 stores programs and models and can calculate to estimate whether the animal is in a tension state or not according to the signals of the breathing state. The computing also can predict the breathing cycles, so as to automatically issue the instructions to eject the drug during the predicted inhalation period. The drug ejection is carried out when the animal is in a non-tension state. The computing device 300 sends the instructions to control the gas ejection timing, the flow rate, the drug release timing, or the like of the drug delivery device 200.

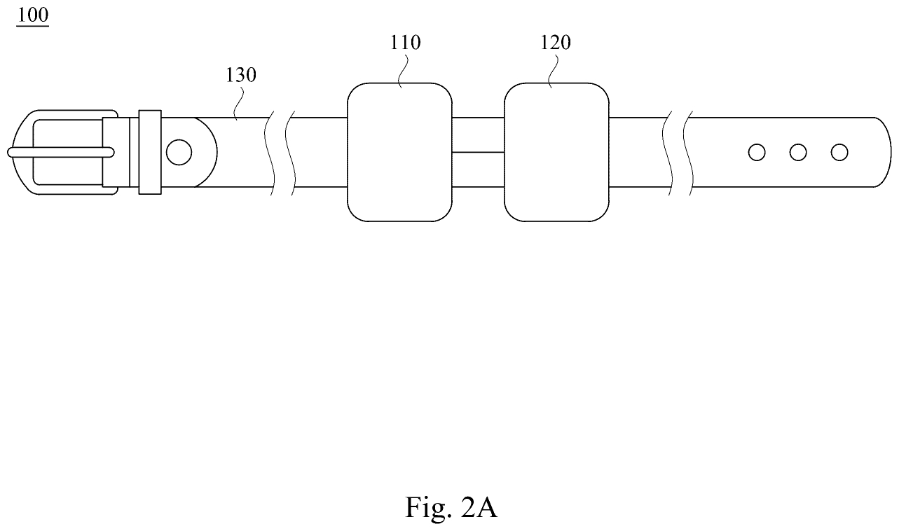

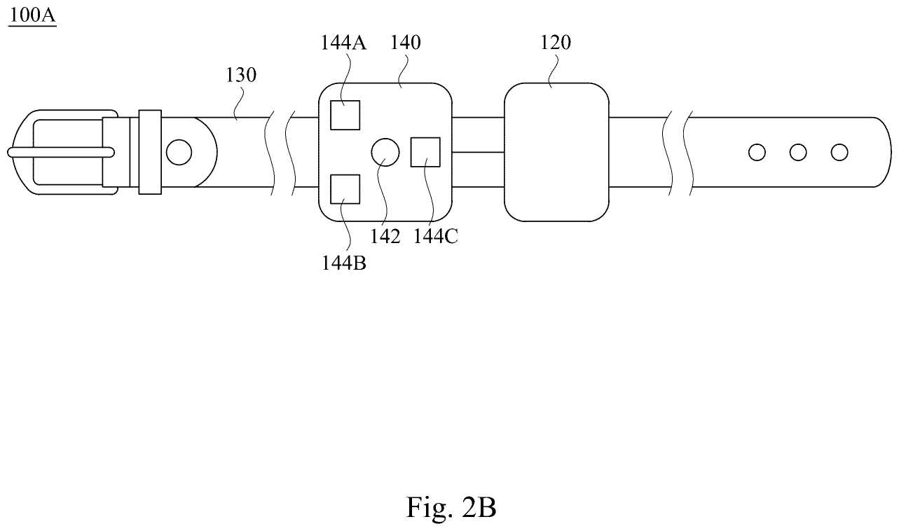

FIG. 2A shows a schematic view of a breath detection device according to some embodiments. The breath detection device 100 includes a signal receiver 110 and a transceiver interface device 120. In some embodiments, the signal receiver 110 may be, for example, a microphone that senses vibrations or sounds. The signals of the breathing state may include the frequencies, the amplitudes, and the sensing timings of the vibrations or the sounds. The transceiver interface device 120 is electrically connected to the signal receiver 110 and is configured to transmit the signals of the breathing state to the computing device 300.

As shown in FIG. 2A, the breath detection device 100 may be in the form of a chest strap and include a soft chest strap 130 to surround the chest of the animal. The tightness of the soft chest strap 130 can be adjusted appropriately, so that the breath detection device 100 can be attached to the body surface of the animal. In other embodiments, the breath detection device 100 can be attached to the animal in the form of a patch that attaches the body surface near the lung of the animal.

FIG. 2B shows a schematic view of a breath detection device according to other embodiments. The breath detection device 100A is a lung sound detector, which includes a patch 140 and a transceiver interface device 120. The patch 140 includes a vibrator 142 and a plurality of signal receivers 144A, 144B and 144C. The vibrator 142 can emit reference vibration signals, and then the signal receivers 144A, 144B and 144C receive the reference vibration signals from the vibrator 142 and a vibration signal from the respiratory system of the animal.

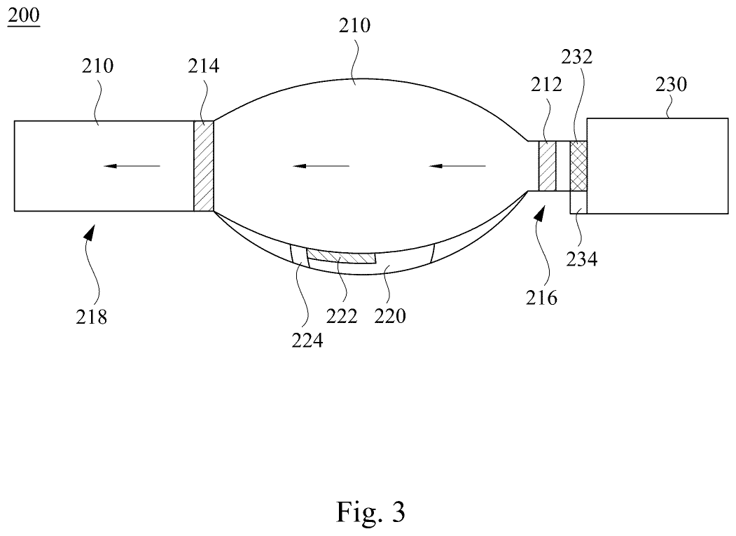

FIG. 3 shows a drug delivery device according to some embodiments. The drug delivery device 200 includes a hose 210, one-way valves 212 and 214, a drug storage tank 220, a drug release valve 222, a drug release controller 224, a gas ejection device 230, a gas valve 232, and a gas release controller 234.

The hose 210 is a conduit configured to be inserted into the mouth of an animal, wherein the hose 210 includes a gas inlet end 216 and a gas outlet end 218. The gas inlet end 216 is connected to the gas ejection device 230, and the gas outlet end 218 is used to be placed in the oral cavity of an animal, and the drug is released from the gas outlet end 218 into the oral cavity of the animal.

The drug storage tank 220 communicates with the hose 210 and is configured to store the dry powder. The drug release valve 222 is disposed between the drug storage tank 220 and the hose 210 and is connected to a drug release controller 224. In some embodiments, the drug delivery device 200 may include one or more drug storage tanks 220. The drug release controller 224 includes a communication element and is configured to receive a drug release instruction from the computing device 300 to control the opening or closing of the drug release valve 222.

The gas ejection device 230 communicates with the gas inlet end 216 of the hose 210 and is configured to eject gas to the gas outlet end 218. The gas ejection device 230 may be a high-pressure gas cylinder or a pump connected to a gas storage container. The gas release controller 234 includes a communication element and is configured to receive a gas ejection instruction from the computing device 300 to control the gas valve 232 to open and eject the gas stored in the gas ejection device 230. The gas release controller 234 may also control and adjust the flow rate of the gas ejection device 230.

The hose 210 is provided with one-way valves 212 and 214, so that the flow direction of the gas in the hose 210 is one-way in the inhalation direction of the animal. The one-way valves can prevent the dry powder from being ejected in the opposite direction due to the exhalation of the animal.

As shown in FIG. 3, the opening of the drug storage tank 220 (that is at the position of the drug release valve 222) is close to the gas outlet end 218 of the hose 210, which helps to reduce the residual dry powder in the hose 210. In addition, the opening of the drug storage tank 220 is separated from the opening of the gas ejection device 230 (that is at the position of the gas valve 232) and controlled by the valve. Therefore, when the drug release valve 222 is closed, the gas ejection device 230 can eject the gas without the dry powder. In some embodiments, before the drug ejection, the gas without the dry powder can be ejected one to several times to the mouth of the animal 20, to help the animal 20 acclimate to the gas ejecting operation of the drug delivery device 200.

In some embodiments, at least one fixing auxiliary device is used to fix the drug delivery device 200 on the head of the animal during drug administration. For example, the teeth of the animal are covered with a mouthguard(s) to prevent the animal from chewing the drug delivery device, and the mouth of the animal is covered with a muzzle. In some embodiments, fixing components, such as locking elements, may be provided on the muzzle or the mouthguard(s) to fix the drug delivery device in the locking position.

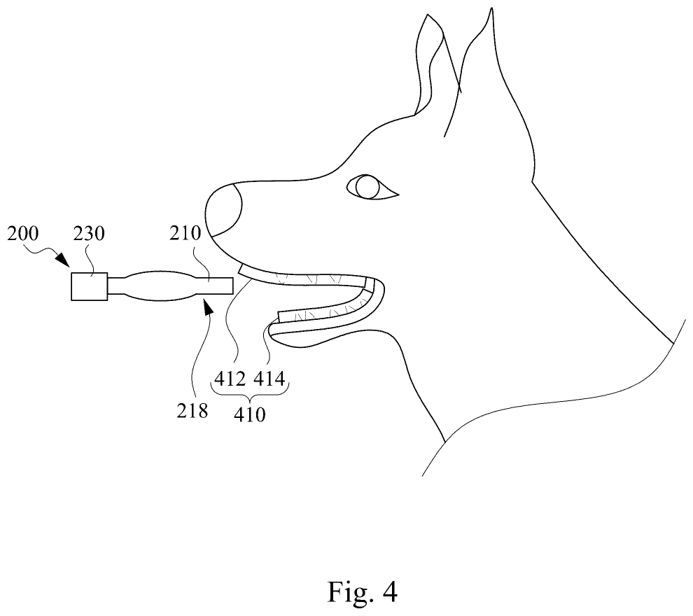

FIG. 4 shows a schematic view of a set of mouthguards for an animal. The set of mouthguards 410 includes an upper mouthguard 412 and a lower mouthguard 414. The gas outlet end 218 of the hose 210 of the drug delivery device 200 is placed between the upper mouthguard 412 and the lower mouthguard 414, and is placed at a depth that prevents the animal from vomiting and feeling uncomfortable.

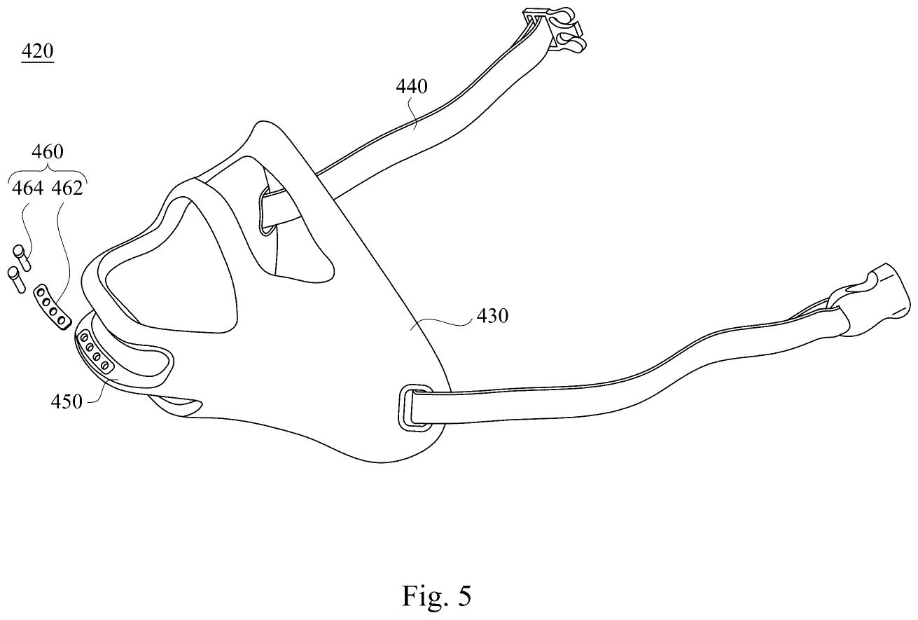

FIG. 5 shows a schematic view of the muzzle of an animal. The muzzle 420 comprises a body 430, which can surround the snout of an animal and expose the mouth and the nose of the animal. The muzzle 420 further includes a strap 440 to fix the position of the body 430 of the muzzle 420. In some embodiments, the body 430 is provided with a locking position 450 near the mouth of the animal, and when the gas outlet end 218 of the hose 210 of the drug delivery device 200 is inserted into the mouth of the animal, a part of the hose 210 is fixed at the locking position 450 by using the locking elements 462 and 464 of the locking components 460. In other embodiments, other types of fixing components are also feasible, such as slots.

In some embodiments, the animal is allowed to inhale the drug through the mouth, and during the inhalation, the animal is allowed to inhale the dry powder only through the mouth.

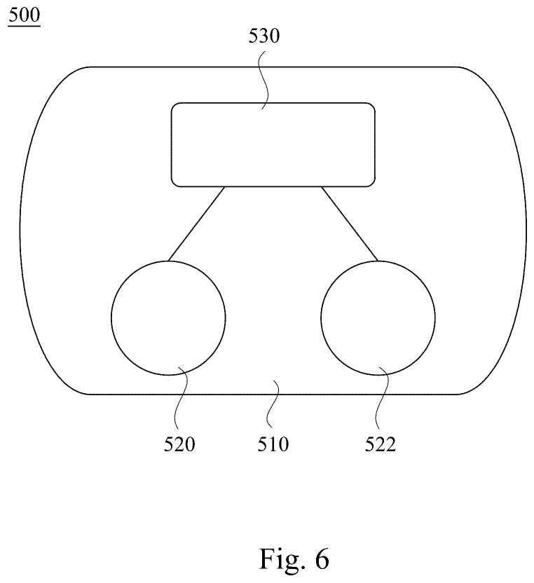

FIG. 6 shows a schematic view of a nasal mask for an animal. The nasal mask 500 includes a body 510, a first airflow valve 520, a second airflow valve 522, and a nasal airflow controller 530. The body 510 covers the nose of the animal, and the first airflow valve 520 and the second airflow valve 522 are respectively disposed at positions corresponding to the two nostrils of the animal. When the first airflow valve 520 and the second airflow valve 522 are closed, the animal cannot breathe through the nose. The nasal airflow controller 530 is electrically connected to the first airflow valve 520 and the second airflow valve 522. The nasal airflow controller 530 further includes a communication element to be communicatively connected to the computing device 300. The nasal airflow controller 530 is configured to receive an inhalation control instruction from the computing device 300. When the inhalation period suitable for administering drug to the animal is reached, the ejection of gas with drug is set to carry out, and at the same time, the first airflow valve 520 and the second airflow valve 522 are set to be closed during this inhalation period.

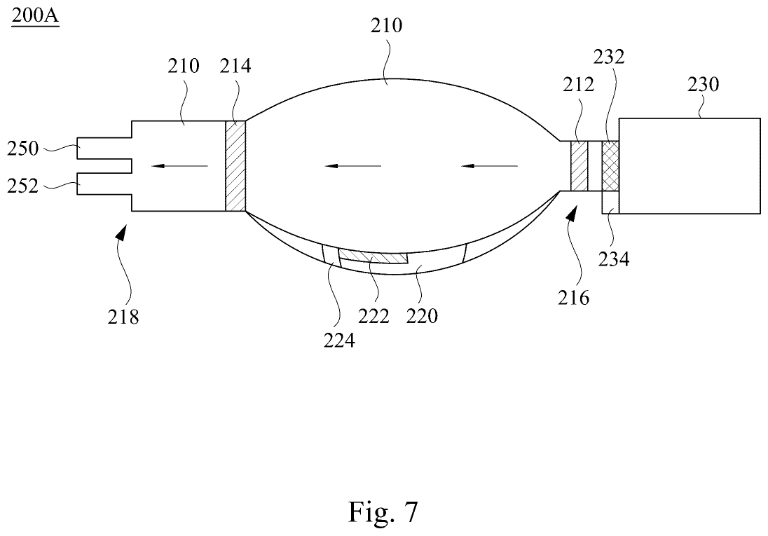

FIG. 7 shows a schematic view of an alternative embodiment of a drug delivery device. The drug delivery device 200A is similar to the drug delivery device 200 of FIG. 3, so similar elements will not be repeated here. The drug delivery device 200A is a drug delivery device for nasal inhalation. Tubes 250 and 252 are provided at the gas outlet end 218 of the hose 210 and are used for insertion into nostrils of the animal.

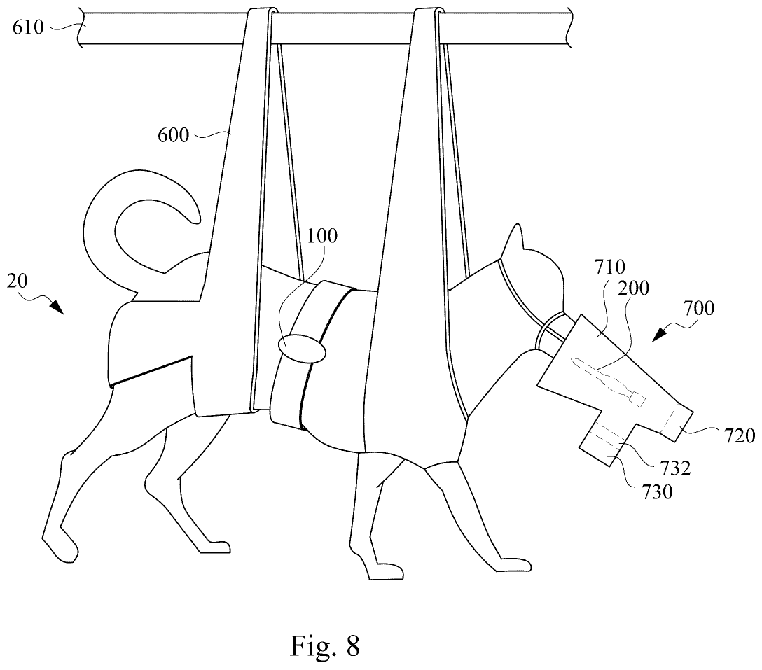

FIG. 8 shows an operation schematic view when conducting an animal experiment on dry powder administration. During the experiment, in order to prevent the animal from struggling, the animal was hung in a hammock 600 with fixtures 610 so that the feet of the animal were off the ground.

In some embodiments, a drug recovery device is also sleeved outside the mouth of the animal 20. As shown in FIG. 8, the drug recovery device 700 includes a transparent cover 710, a filter 720, and a powder collector 730. The filter 720 is used to prevent the dry powder exhaled by the animal from leaking to the external environment. In some embodiments, a one-way valve 732 is provided in the powder collector 730, so that dry powder exhaled by the animal can be discharged in the direction of exhalation without being re-inhaled by the animal 20. The powder collector 730 of the drug recovery device 700 is used to collect the dry powder exhaled by the animal through the airflow, and recover the dry powder so that the animal 20 would not inhale the dry powder again, so as to calculate the actual amount of the dry powder entering the body of the animal 20.

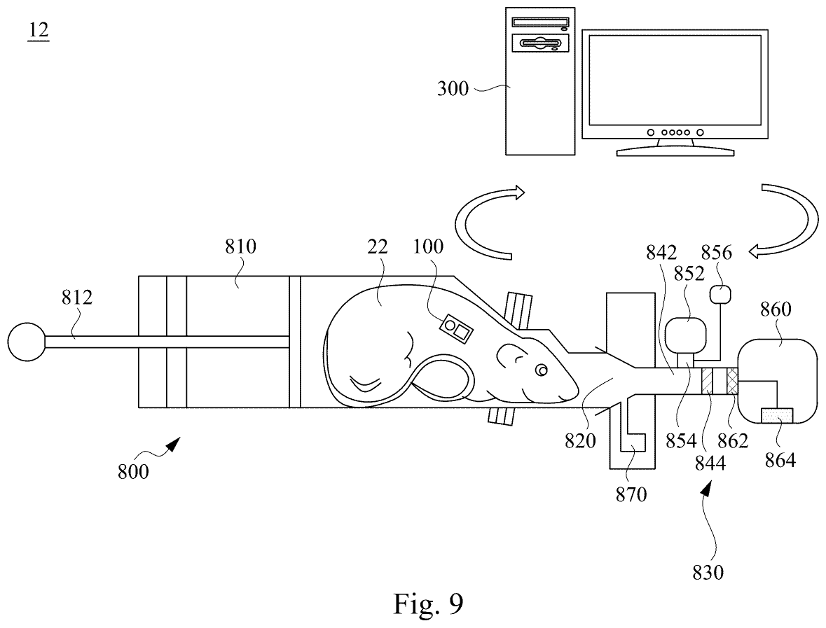

FIG. 9 illustrates a dry powder inhalation system according to some embodiments. The dry powder inhalation system 12 can be used for a rodent model. Rodents breathe through their noses and are relatively small in size. The dry powder inhalation system 12 includes a breath detection device 100, a holding chamber 800, a drug delivery device 830, a computing device 300, and a powder collector 870. The holding chamber 800 is used to accommodate the animal 22. The holding chamber 800 includes an accommodating cavity 810, a stopper 812 and a sleeve 820. The stopper 812 and the sleeve 820 are respectively located at the opposite two ends of the accommodating cavity 810. The animal 22 is placed in the accommodating cavity 810, and then the buttock of the animal 22 is held by the stopper 812, so that the snout (including the nose and mouth) of the animal 22 is covered by the sleeve 820. That is, at this time, the snout of the animal 22 are close to the drug outlet of the drug delivery device 830.

The drug delivery device 830 includes a conduit 842, a one-way valve 844, a drug storage tank 852, a drug release valve 854, a drug release controller 856, a gas ejection device 860, a gas valve 862, and a gas release controller 864. In some embodiments, the one-way valve 844, the drug storage tank 852, the drug release valve 854, the drug release controller 856, the gas ejection device 860, the gas valve 862, and the gas release controller 864 may be similar to the one-way valve 212, the drug storage tank 220, the drug release valve 222, the drug release controller 224, the gas ejection device 230, the gas valve 232, and the gas release controller 234 described in FIG. 3.

As shown in FIG. 9, the conduit 842 communicates with the sleeve 820. When the dry powder is administered, the gas with dry powder can flow into the conduit 842 and then enter the sleeve 820, and be inhaled into the lungs through the nose of the animal 22.

As shown in FIG. 9, the animal 22 is provided with a breath detection device 100, which includes a signal receiver and a transceiver interface device. The computing device 300 receives the signals of the breathing state from the breath detection device 100 and can evaluate the stress state or other physiological conditions of the animal 22, predict the breathing cycles of the animal 22, and send the instructions to the drug release controller 856 and the gas release controller 864, so that the animal 22 autonomously inhale the dry powder during a predicted inhalation period. In some embodiments, the animal is not anesthetized during the preferred predicted inhalation period. By ejecting dry powder during the inhalation period of the animal 22, instead of continuous exposure for a period of time, the attachment of the dry powder to the fur of the animal 22 can be reduced.

Because rodent animals may lick their fur, the dry powder may be taken orally after attaching to the fir of the rodent animals. Moreover, compared with inhalation administration to the lungs, the route of drugs entering the stomach and then entering the blood is slower, which can affect the performance of the blood concentration curve. Therefore, controlling the release of dry powder only during the inhalation period of the animal for appropriate drug administration can significantly reduce the experimental errors caused by dry powder adhering to the fur of the animals.

As shown in FIG. 9, the powder collector 870 communicates with the sleeve 820 to collect the dry powder exhaled by the airflow from the exhalation of the animal 22 or the dry powder not inhaled by the animal 22, so as to calculate the actual amount of the inhaled dry powder.

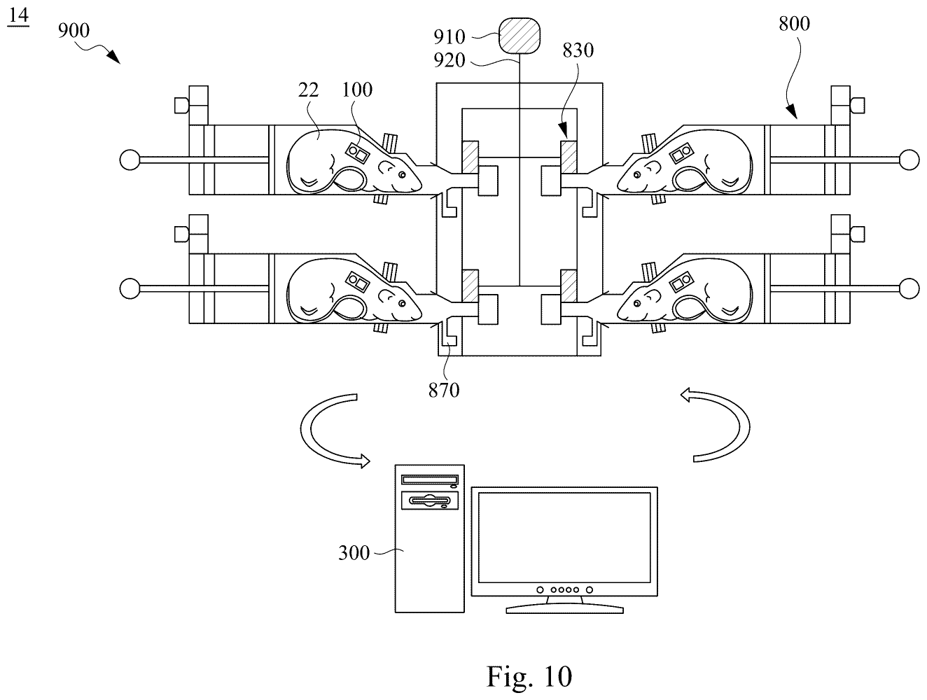

FIG. 10 shows a dry powder inhalation system according to other embodiments. The dry powder inhalation system 14 includes an inhalation tower 900, which is used to perform drug administration operations on multiple animals at the same time, and the drug administration operations for the multiple animals are carried out in a consistent manner. The inhalation tower 900 may be provided with a plurality of holding chambers 800, and each of the holding chamber 800 communicates with a respective drug delivery device 830 and a powder collector 870. That is to say, the animals in respective holding chambers are individually controlled for administration.

In the drug pipeline of the conventional drug inhalation tower, because the dry powder may sink, especially the larger dry powder particles sink faster, the animals in the lower holding chambers may be exposed to more dry powder. Therefore, the administration status of the same batch of animals administered in the inhalation tower may be less consistent. In contrast, the dry powder inhalation system 14 of the present disclosure can control the dry powder to be ejected at specific administration time points for each of the animals, so there is no difference in drug exposure caused by the position of the holding chamber and drug particle deposition, and the release amount, the recovery amount, the inhalation amount, or the like of the dry powder can be calculated for each of the animals.

As shown in FIG. 10, the inhalation tower 900 includes a dry powder supply mechanism 910, which is communicated to each drug delivery device 830 via a pipeline 920. The pipeline 920 may be, for example, a plastic hose.

In some embodiments, the inhalation tower 900 is used to administer drug to a plurality of animals, such as mice or rats, for a longer period of time, such as several hours. Non-single-time of spraying is administered to the respective animals through the respective drug delivery devices 830. The breathing conditions of the animals are monitored through the breath detection devices 100 respectively disposed on each of the animals and transmitted to the computing device 300. Then, the computing device 300 can predict the inhalation period of each of the animals and control each of the drug delivery devices 830 to eject the gas with the dry powder during the suitable inhalation period of each of the animals.

Various embodiments of the present disclosure also provide a dry powder administration method, which includes: placing a breath detection device on the body of an animal; disposing a drug delivery device, wherein the drug delivery device is configured to deliver a dry powder to the lungs of the animal through the oral cavity or the nasal cavity of the animal; monitoring the breathing state of animal to evaluate the stress state of the animal and predict the breathing cycles of the animal; ejecting the dry powder for inhalation by the animal during a non-stressed inhalation period.

In some embodiments, the current stress state of the animal is determined by detecting the signals of the breathing state of the animal. For example, when the animal is in a tension state, the breathing cycle is short, the breathing may be shallow or irregular, or the inhaled air volume is small. During periods when the animal is not tense (i.e., more relaxed or calm), the breathing cycle is more even, and the inhalation goes deeper into the lungs. Therefore, the tension state of animals can be evaluated by the breathing signals, such as lung sound signals, or the like.

In some embodiments, the animal is not anesthetized, so that the animal can inhale the dry powder in a conscious state and able to breathe on its own (i.e., breathe spontaneously).

In one embodiment, taking a dog as an example, during drug administration, the drug storage tank of the drug delivery device can be filled with a dry powder to be ejected, a gas ejection device is connected, and the intubation of the drug delivery device (that is, the outlet end of the hose) is installed on a mouthguard(s) for the dog. Then, the mouthguard(s) is/are disposed in the mouth of the dog and fixed on a muzzle for the dog. The drug delivery device is communicatively connected to the computing device via wireless communication. At the same time, a breath detection device, such as a lung sound detection device, is attached to the body surface near the lungs of the dog and is communicatively connected to the computing device via wireless communication.

At the beginning, the breathing state, such as the breathing frequency, of the dog is measured to determine whether the dog is in a tension state or not. Try to conduct the experiment in a relaxed state of the dog. When the exhalation and inhalation are measured and the breathing cycle can be accurately predicted, the dry powder is ejected during the next predicted inhalation. In addition, in order to prevent the dog from being uncomfortable or nervous, the gas without the dry powder can be ejected several times to the mouth of the dog in advance to help the dog get accustomed. In some embodiments, by ejection of the gas without the dry powder, the signals of the breathing state when the animal received the gas ejection are collected and analyzed; then, the signals may be used to calibrate the measured breathing frequency, to improve the accuracy of prediction for the breathing cycle.

In some implementations, during the drug administration, the animal is not anesthetized, allowing the animal to autonomously inhale the drug while in a conscious state. This better simulates the clinical situation in humans where inhaled drugs are administered orally or nasally to the lungs.

In some embodiments, by detecting the lung sound or the breathing frequency, relevant signals are collected to accurately predict the next inhalation period of the animal, during which the gas with dry powder (or aerosol) is directly ejected into the mouth or nose of the animal.

Because the tension state of the animal will affect the breathing frequency and the inhalation amount of the drug, when the drug is administered, the dry powder is ejected during a non-stressed inhalation period of the animal.

In some embodiments, a machine learning classification model is used to collect signals of breathing states, such as lung sound signals, of animals under different stress states. The trained model can then be used to evaluate the stress states of the animals and predict their breathing cycles. For example, animals have their own corresponding breathing patterns when they are stressed and when they are not stressed. In some embodiments, deep learning, neural network models, or machine learning algorithms such as decision trees, K-means clustering, Bayesian classifiers, or the like may be selected and used.

Next, the established classification model can be used. When receiving the signals transmitted from the breath detection device, the computing device can quickly identify whether the animal is in a tension state and predict the animal's breathing cycles. When the animal is in a non-stressed state, a drug ejection instruction is sent to the drug delivery device at the beginning of the predicted inhalation action of the animal.

In some embodiments, the mode of administration may be optimized via machine learning. By detecting the breathing frequency, the timing of a single drug ejection can be set, for example, the drug ejection may occur at the beginning, middle, or end of the predicted inhalation period. Then, the best drug ejection time point is learned via the amount of the recovered dry powder; for example, the less, the better.

In other embodiments, the dosage for each drug ejection administered to the animal can be optimized through machine learning, such as determining the maximum dosage or a more optimal dosage. This is because if too much dry powder is ejected in a single dose, the animal may suffocate, or the dry powder may directly induce the animal to cough, or the animal may have other immediate respiratory reactions, such as choking, wheezing, or difficulty breathing.

In some embodiments, machine learning is used to correct or compensate for differences in human operations, differences between individual animals, or other differences. Furthermore, multiple experiments can be conducted, using the data from previous experiments to calibrate the accuracy of subsequent experiments. For example, the breathing signals, such as the lung sound signals, of a certain animal before each drug administration experiment are independent of the drug administration operation itself. Signals from multiple experiments can be collected to establish for a judgment of whether the animal is “in a tension state” (i.e., in a stressed state) or “in a non-tension state” (i.e., in a non-stressed state). In addition, the upper limit of the drug ejection dose may be determined by the dosage of multiple experiments and the respiratory responses of the animals. For instance, the upper limit of the dosage that avoids causing the animal to cough can be obtained.

The dry powder inhalation system and dry powder administration method according to the embodiments of the present disclosure mainly rely on detecting the breathing signals, such as lung sound, breathing frequency, or the like, and directly ejecting a dry powder or an aerosol into the mouth or nose during the inhalation period of the animals, so as to reduce errors and achieve more accurate experimental results.

Compared with the prior art, the dry powder inhalation system for animal experiments according to the embodiments of the present disclosure makes up the blank that there is no effective inhalation device for animal experiments in the current market, improves the accuracy of animal experiments, is simple and practical, and the drugs in the drug delivery device are well dispersed and well absorbed for the animals. Furthermore, the disclosed drug delivery device may be manufactured in different specifications, making it suitable for various types of animals. The dry powder inhalation system disclosed in the embodiments of the present disclosure can effectively deliver dry powder to the bronchopulmonary region through the trachea of animals, and can be widely used in experimental research in medicine, pharmacy, biology, environmental science, or the like.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A dry powder inhalation system comprising:
a breath detection device configured to monitor a breathing state of an animal and transmit signals of the breathing state;
a drug delivery device configured to deliver a dry powder orally or nasally to lungs of the animal;
a computing device configured to receive the signals of the breathing state, evaluate a stress state of the animal, predict a breathing cycle of the animal, and control the drug delivery device to release the dry powder during a non-stressed inhalation period for the animal to inhale the dry powder autonomously.

2. The dry powder inhalation system of claim 1, wherein the breath detection device comprises:
a signal receiver configured to detect the signals of the breathing state of the animal; and
a transceiver interface device connected with the signal receiver and configured to transmit the signals of the breathing state to the computing device.

3. The dry powder inhalation system of claim 1, wherein the breath detection device is a lung sound detector, comprising:
a vibrator, wherein the vibrator is configured to emit reference vibration signals;
a plurality of signal receivers, wherein the plurality of signal receivers are configured to receive respiratory vibration signals from the animal and the reference vibration signals from the vibrator; and
a transceiver interface device connected to the plurality of signal receivers and configured to transmit the respiratory vibration signals from the animal and the reference vibration signals from the vibrator to the computing device.

4. The dry powder inhalation system of claim 1, wherein the drug delivery device comprises:
a conduit, wherein the conduit comprises a gas inlet end and a gas outlet end;
a drug storage tank, connected with the conduit and configured to store the dry powder; and
a gas ejection device connected to the gas inlet end of the conduit and configured to eject a gas toward the gas outlet end.

5. The dry powder inhalation system of claim 4, wherein the drug storage tank is located near the gas outlet end of the conduit.

6. The dry powder inhalation system of claim 4, wherein the drug delivery device further comprises:
a drug release valve disposed between the conduit and the drug storage tank; and
a drug release controller electrically connected to the drug release valve and configured to receive a drug release instruction from the computing device to control opening or closing of the drug release valve.

7. The dry powder inhalation system of claim 4, wherein the drug delivery device further comprises:
a gas valve disposed between the gas ejection device and the gas inlet end of the conduit; and
a gas release controller electrically connected to the gas valve and configured to receive a gas ejection instruction from the computing device to control opening or closing of the gas valve.

8. The dry powder inhalation system of claim 1, further comprising: a nasal mask, comprising:
a body;
a first airflow valve and a second airflow valve, located in the body and respectively disposed at positions corresponding to two nostrils of the animal; and
a nasal airflow controller configured to receive an inhalation control instruction from the computing device and close the first airflow valve and the second airflow valve during the non-stressed inhalation period of the animal.

9. The dry powder inhalation system of claim 1, wherein the dry powder inhalation system further includes a fixing auxiliary device configured to fix the drug delivery device.

10. The dry powder inhalation system of claim 1, wherein the fixing auxiliary device includes a muzzle configured to fix a mouth of the animal.

11. The dry powder inhalation system of claim 1, wherein the computing device uses a classification model to obtain a breathing pattern of the animal and predicts the non-stressed inhalation period.

12. The dry powder inhalation system of claim 11, wherein the computing device is further configured to obtain the suitable dosage range of the dry powder for the animal.

13. The dry powder inhalation system of claim 1, further comprising:
a drug recovery device configured to collect an exhaled dry powder from the animal.

14. The dry powder inhalation system of claim 1, further comprising:
a holding chamber configured to accommodate the animal, wherein the holding chamber comprises a sleeve configured to position a snout of the animal close to a drug outlet of the drug delivery device.

15. The dry powder inhalation system of claim 1, further comprising:
an inhalation tower comprising a plurality of holding chambers, wherein each of the plurality of holding chambers is provided with the drug delivery device.

16. A dry powder administration method, comprising:
placing a breath detection device near lungs of an animal;
disposing a drug delivery device, wherein the drug delivery device is configured to deliver a dry powder to lungs of the animal through an oral cavity or a nasal cavity of the animal;
monitoring a breathing state by the breath detection device to evaluate a stress state of the animal and predict a breathing cycle of the animal; and
ejecting the dry powder for inhalation by the animal during a non-stressed inhalation period.

17. The dry powder administration method of claim 16, further comprising:
recovering an exhaled dry powder from the animal; and
calculating an inhalation amount of the dry powder of the animal.

18. The dry powder administration method of claim 16, wherein the drug delivery device is inserted into the oral cavity of the animal, and the nasal cavity of the animal is masked during the non-stressed inhalation period.

19. The dry powder administration method of claim 16, wherein before ejecting the dry powder for inhalation by the animal during the non-stressed inhalation period, ejecting a gas without the dry powder to the oral cavity or the nasal cavity of the animal during another non-stressed inhalation period.

20. The dry powder administration method of claim 16, wherein the animal is suspended in a hammock or placed in a holding chamber.
